(19) United States
(12) Patent Application Publication
(10) Pub. No.: US 2011/0295667 A1
(43) Pub. Date: Dec. 1, 2011

(54) Interactive advertising System

(76) Inventor: David Butler, Mountain View, CA (US)

(21) Appl. No.: 12/932,436

(22) Filed: Feb. 25, 2011

Related U.S. Application Data
(60) Provisional application No. 61/368,112, filed on Jul. 27, 2010.
(60) Provisional application No. 61/396,701, filed on Jun. 1, 2010.

(51) Int. Cl. G06Q 30/00

(52) U.S. Cl. 705/14.12; 705/14.53; 705/14.39

(57) ABSTRACT

A system and computerized process for interactive display of advertisements is contemplated. The computerized process is embodied by online software that enables end users to voluntarily view and interact with an advertisement. Incentives may be offered for interacting with the advertisement. The incentives may relate to data transmission parameters such as data transmission rate. The incentives may be based on a monitored level of interaction by a user with the advertisement. Upon acceptance and/or interaction with the advertisement the transmission rate of the file may be increased up to the limit of the bandwidth otherwise available to the user.

### RELATED APPLICATIONS

This application claims the benefit of U.S. Provisional Patent Application Ser. No. 61/368,112 titled Interactive Advertising System, filed on Jul. 27, 2010, and also claims the benefit of U.S. Provisional Patent Application Ser. No. 61/396,701 titled Interactive Advertising System, filed Jun. 1, 2010, both filed by the inventor of the present application, the contents of which are incorporated herein by reference.

### FIELD OF THE INVENTION

The present invention relates generally to the field of online advertising and in particular to a system and method for incentivizing interaction with an advertisement.

### BACKGROUND

Drawing and maintaining the attention of a viewer to an advertisement continues to be a problem in the field of advertising. This problem persists in various forms of advertising including online advertising. Online advertisements are delivered to viewers in a variety of manners, e.g. by way of pop-up ads, banner ads or the like. Many websites such as file hosting websites and websites that stream various forms of media (e.g. audio and video) provide services that involve periods of inactivity. These periods of inactivity can occur while a user is waiting for a file to download or upload or for a streamed media segment to begin playing. Some websites take advantage of these periods of inactivity by displaying advertisements.

Existing solutions attempt to increase a viewer's interest in an advertisement in a number of ways. One such method for increasing interest is to select advertisements that are potentially more relevant to the particular user viewing the advertisement. However, viewers often remain apathetic to such displayed advertisements, frequently ignoring the advertisements and sometimes even developing animosity towards the web site or the brand associated with the advertisement being displayed.

Therefore, given the limitations of existing solutions, it would thus be desirable to have a system and method for delivering advertisements during periods of inactivity that are better able to draw in and maintain the users attention.

### SUMMARY OF THE INVENTION

In view of the foregoing, it is therefore an object of the present invention to provide a system and method for delivering advertisements that does not suffer from the drawbacks of known solutions. In particular, it is an object of the present invention to provide a system and computerized method for delivering advertisements during periods of inactivity that are better able to draw in and maintain a user's attention.

The present invention advantageously fills the aforementioned needs by providing a system together with an associated computerized process. The system is comprised of the following components: a media server; and at least one client device communicatively coupled to the media server. The media server is configured to transmit or receive data (e.g. files or data packets) to or from the client devices, to initiate transmission of interactive advertisements to the client devices, and to monitor a user's interaction with the interactive advertisements. The client devices are configured to display interactive advertisements. The client devices may also be configured to display (e.g. within a file transfer dialog box) transmission parameters (e.g. transmission rate) associated with a file being transmitted. The interactive advertisement may be displayed within the file transfer dialog box or as a separate display element. The system may optionally include an advertisement server communicatively coupled to the media server and the at least one client device, the advertisement server being configured to deliver the interactive advertisements to the client devices.

The exemplary components are related as follows: a user connects with the media server by way of one of the client devices; the user indicates to the media server a file the user wishes to download or upload; the media server receives the transmission request; in response, the media server transmits information to the client device, the information being suitable for conveying (e.g. by displaying within a dialog box) current data transmission parameter values (e.g. transmission rate) and for displaying an interactive advertisement (either within the dialog box or as separate interface element); the media server also begins transmission of the file; when the user interacts with the advertisement, interaction notifications are sent to the media server; the media server receives the interaction notifications and monitors the interaction notifications to determine updated transmission parameter values (e.g. file transmission rate). The media server may modulate the file transmission rate in response to the received interaction notifications. By way of example, the media server may increase the transmission rate when detecting that the user has interacted with the advertisement or may increase the transmission rate upon detecting that the user has completed a predetermined amount of interaction with the advertisement. The media server may alternately be configured to decrease the transmission rate upon detecting that the user has slowed or stopped interacting with the interactive advertisement. The media server may also be configured to log communication that is transmitted between the media server and the one or more client devices. The media server may also provide the user with an option of choosing between two or more transmission rates. When receiving a selection of the slowest transmission rate option the media server begins transmission or receipt of the file to or from the client device, monitors the progress of the download, and then makes the file available for download or accepts the file for upload once the transmission of the file has completed. In effect, the user is allowed to opt out of viewing the advertisement when selecting the slowest transmission rate. When choosing a higher transmission rate the transmission of the file is initiated at a slower rate and then modulated as previously discussed based on the monitored interaction of the user with the interactive advertisement. The media server module may alternately initiate transmission of the file at one of the faster transmission rate options. The media server releases the file for download or accepts the file for upload once the file has been successfully transmitted to or from the client device. The media server may also determine whether the user has successfully completed interaction with the interactive advertisement prior to releasing the file for download or accepting the file for upload.

In another exemplary aspect a computerized process is contemplated that is performed by a media server, the process comprising the steps of: receiving a request for a file from a client device; transmitting information to the client device, the information being suitable for displaying a dialog box for showing a variable transmission speed, a transmission status showing a level of file transmission completion, and an interactive advertisement for display either within the dialog box or in a separate interface window; initiating transmission of the file to the client device at an initial transmission rate; receiving one or more interaction notifications from the client device, the interaction notifications indicating interaction by the user with the interactive advertisement; and increasing the transmission rate when the interaction notifications indicate that the user is interacting with the interactive advertisement or has completed a predetermined level of interaction with the interactive advertisement.

The computerized process may further comprise the steps of: determining whether the user has completed a predetermined level of interaction with the interactive advertisement and subsequently allowing said file to be released for download or accepted for upload.

The computerized process may also comprise the steps of: transmitting a request to the client device for the user to select a desired transmission rate from a plurality of predetermined transmission rates; receiving a user selection of the desired transmission rate from the client device; wherein the initial transmission rate is selected from one of: a rate slower than the selected transmission rate, the selected transmission rate, and a rate higher than the selected transmission rate.

The computerized process may also comprise the steps of: decreasing the transmission rate when the interaction notifications indicate that the user has not interacted with the advertisement, has stopped interacting with the advertisement or is interacting with the advertisement at a slower rate.

The computerized process may also comprise the steps of: capping the transmission rate to the slowest transmission rate option when the user selects the slowest rate; and allowing the file to be released for download or accepted for upload without receiving indication that the user has interacted with the advertisement.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows a block diagram illustrating an interactive advertising system in accordance with an exemplary embodiment of the invention.

FIG. 2 shows a block diagram illustrating an interactive advertising system in accordance with another exemplary embodiment of the invention.

FIG. 3 shows a flow diagram in accordance with an exemplary embodiment of the invention.

FIG. 4 shows a flow diagram in accordance with another exemplary embodiment of the invention.

FIG. 5 shows a flow diagram in accordance with another exemplary embodiment of the invention.

FIG. 6A shows an interface diagram in accordance with an exemplary embodiment of the invention.

FIG. 6B shows an interface diagram in accordance with another exemplary embodiment of the invention.

FIG. 7 shows a flow diagram in accordance with another exemplary embodiment of the invention.

### DETAILED DESCRIPTION

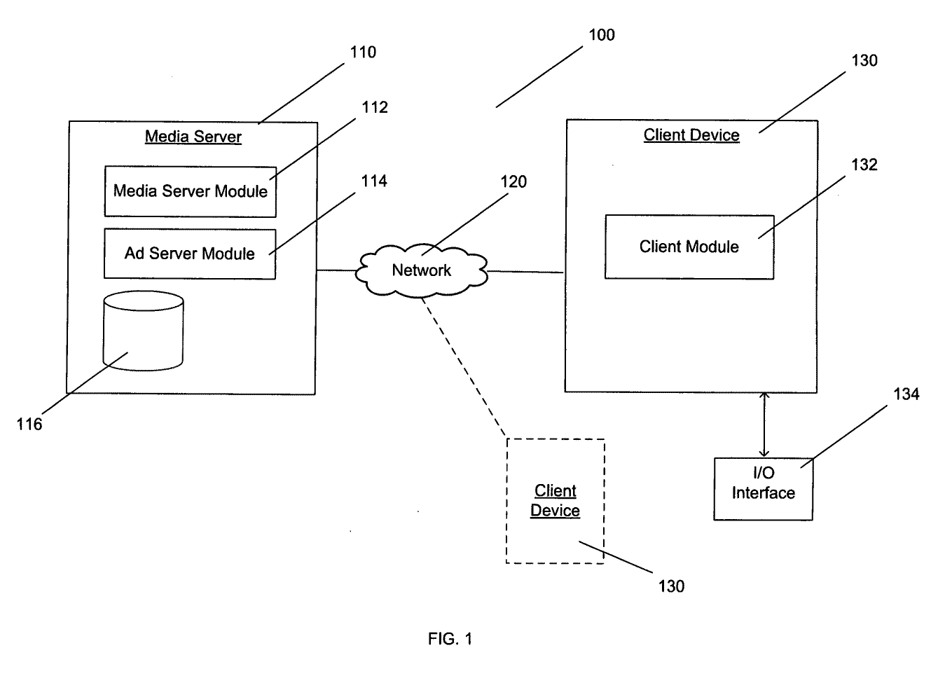

Referring to FIG. 1, a block diagram is shown illustrating an interactive advertising system 100 in accordance with an exemplary embodiment of the invention. The interactive advertising system 100 comprises one or more client devices, labeled generally as 130, each of which includes a client module 132, and a user Input/Output (I/O) interface 134. By way of example, the client device 130 may be a computing device having a processor and memory such as personal computer, a phone, a mobile phone, or a personal digital assistant. The client I/O interface 134 may include a keyboard, mouse, monitor, touch screen or similar interface device suitable for allowing a user to interact with the client device 130. The client module 132 is responsible for handling communication with a media server 110 (e.g. a file hosting, streaming media or gaming server) and for providing a user interface to a user of the client device 130. The interactive advertising system 100 may also include a media server 110 communicatively coupled to each of the client devices 130 by way of a network 120 such as the Internet. The media server 110 includes a media server module 112, an advertisement server module 114 and a data repository 116 for storing files (e.g. text files, audio files or video files) and interactive advertisement data. By way of example, the media server device 110 may be a single computing device having a processor and memory or may include multiple computers communicatively coupled in a distributed cloud-based architecture. The media server module 112 is responsible for handling communication with each of the client devices 130, for managing storage and delivery of files and may access the data repository 116 in response to a file request from one of the client devices 130. The media server 110 may be configured to perform either streaming or non-streaming delivery of files to the client devices 130 (depending, for example, on the type of file being delivered). The advertisement server module 114 is responsible for managing and delivering interactive advertisements and may access the data repository 116 in response to a file request from one of the client devices 130.

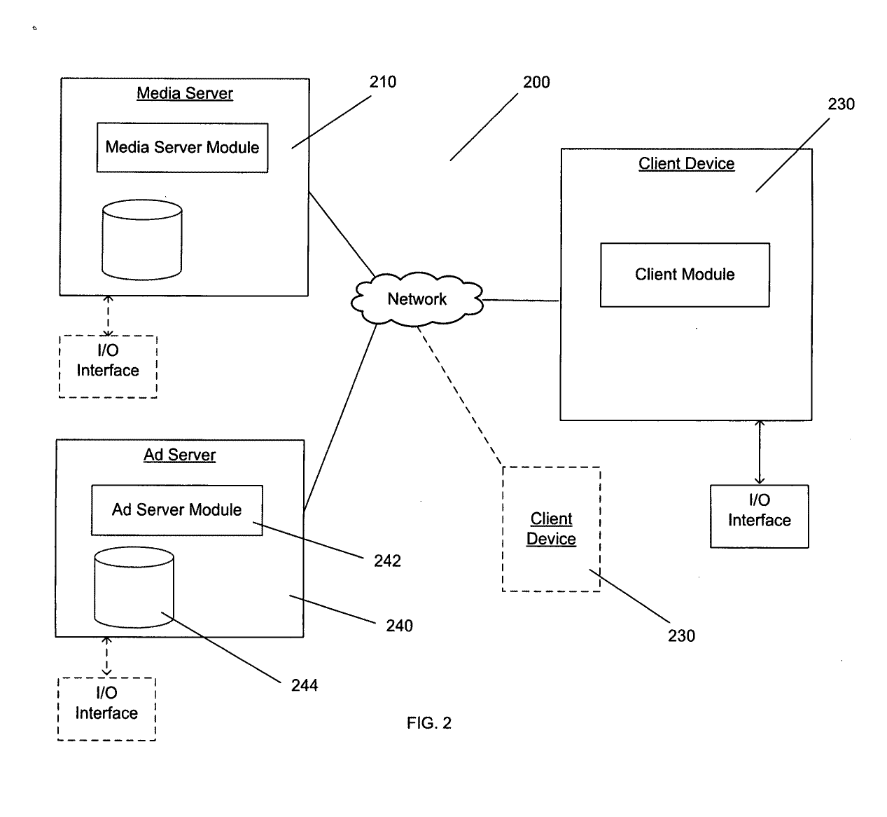

Referring now to FIG. 2, a block diagram is shown illustrating an interactive advertisement system 200 in accordance with another exemplary embodiment of the invention. The interactive advertisement system 200 is configured in a similar manner to the interactive advertisement system 100 of FIG. 1. As shown, the interactive advertisement system 200 may also include an advertisement server 240 communicatively coupled to a media server 210 and optionally to one or more client devices, labeled generally as 230. In the exemplary embodiment the advertisement server 240 includes an advertisement server module 242. The advertisement server 240 may also include a data repository 244 for storing interactive advertisement data. The advertisement server module 242 is responsible for managing and delivering interactive advertisements and may access the data repository 244 in response to a file request from one of the client devices 230. By way of example, the advertisement server 240 may be a single computing device having a processor and memory or may include multiple computers communicatively coupled in a distributed cloud-based architecture. The advertisement server 240 may deliver interactive advertisements directly to the client device 230 in response to a request from the media server 210 or may deliver the advertisements to the media server 210 which subsequently sends the advertisements to the client device 230.

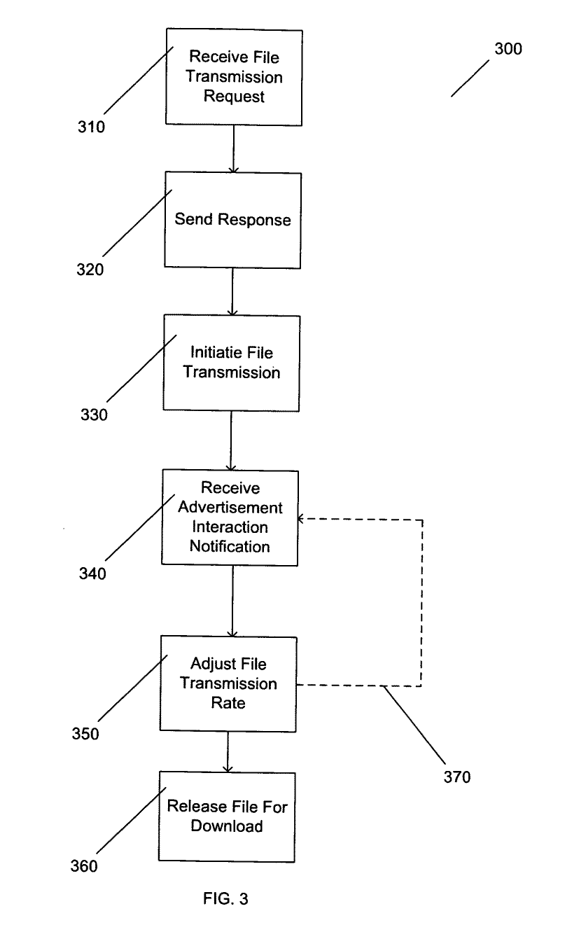

Referring now to FIG. 3, a flow diagram in shown that illustrates a computer-implemented method 300 that may be carried out with the exemplary interactive advertisement system 100. FIG. 3 illustrates a series of steps that may occur between the media server device 110 and one of the client devices 130. At a first step 310 the media server device 110 receives a file transmission request from the client device 130. The file transmission request may be a request to download or stream the contents of a file stored on the media server 110 or to upload a locally stored file to the media server 110. The file transmission request may be initiated by a user interacting with a user interface displayed on the client device 130. By way of example the user interface may be provided within a web browser. After receiving a file transmission request the process proceeds at a next step 320 when the media server 110 prepares and transmits a response to the client device 130. The response may include information such as an initial transmission rate (e.g. kb/s) and an interactive advertisement to be displayed at the client device 130. The information provided in the response is suitable for conveying (e.g. by displaying within a dialog box) current data transmission limitations (e.g. data transmission rate) and for displaying the interactive advertisement. The interactive advertisement may be displayed within a file transfer dialog box or as separate interface element. The response may optionally include information for requesting a desired transmission rate, for example, by including a list of transmission rate options which the user may select from. At a next step 330, the media server module 112 initiates transmission of the file to or from the client device 130 at the initial transmission rate. The initial transmission rate may be an uncapped rate (controlled, for example, by the physical constraints of the media server, the client device and the user's Internet Service Provider) or may be a capped rate set by the media server 110 at a predetermined rate such as one of the transmission rate options provided to the user. The initial transmission rate may also be determined based on other factors such as the size of the file being transferred, the resolution of the video/audio if being streamed and the amount of bandwidth currently being utilized by other users having active file transfers with the media server 110. At a next step 340 the media server module 112 receives an interaction notification message from the client device 130. The interaction notification messages are messages sent from the client device 130 by the client module 132 to the media server 110. The interaction notification messages contain status indicators related to the user's interaction with the interactive advertisement. The client module 132 may capture button clicks or similar mouse or keyboard events and include such events in the notification messages sent to the media server 110. The client module 132 may also detect that the user has completed a predetermined level of interaction (e.g. completion of a form or survey) with the interactive advertisement and include such information in the interaction notification message. It is noted that this determination may alternately be carried out by the media server module 112. At a next step 350 the media server module 112 modulates the file transmission rate in response to such notification events. The transmission rate cap (or maximum rate) may be variable throughout the file transmission process thereby allowing the media server module 112 to modulate the transmission rate multiple times (as indicated by arrow 370) during the file transmission process. The transmission rate cap may be increased when a notification message has been received indicating that the user has interacted with the interactive advertisement or when a predetermined interaction level has been reached. The transmission rate of the file may increase up to the limit of the bandwidth otherwise available to the user as a result of the limits placed thereon by an Internet Service Provider. The transmission rate cap may also be decreased when the user slows interaction, stops interacting or otherwise fails to interact with the interactive advertisement. The amount by which the rate cap is increased or decreased in response may also be randomly selected or based on additional factors such as the size of the file being transmitted, the resolution of the video/audio if being streamed or the amount of bandwidth currently being utilized by other users having active file transfers with the media server 110. The amount by which the rate cap is modulated may also be based on factors related to a level of interaction that the user agrees upon which may relate to the length, duration or complexity of the interactive advertisement. By way of example, an offer may be made to the user to receive a first lower bandwidth incentive (e.g. double a base rate) for agreeing to interact with an interactive advertisement having a shorter duration (e.g. 4 minutes) as well as a second higher bandwidth incentive (e.g. ten times the base rate) for agreeing to interact with an interactive advertisement having a longer duration (e.g. 8 minutes). The media server module 112 may also send additional response messages to the client module 132 each time the file transmission rate cap has been modulated or on a periodic basis. The additional response messages allow the modulated file transmission rate to be displayed to the user (e.g. in a file transmission dialog box), thereby encouraging the user to begin, continue or increase the rate at which they are interacting with the interactive advertisement. At a next step 360, the media server module 112 may release the file for download or accept the file for upload once the file has been successfully transmitted to or received from the client device 130. The media server module 112 may optionally make a segment of the file available for use (e.g. viewing or listening) prior to the file being fully transmitted to the client device 130. This may occur when the media server 110 streams the file to the client device 130. When the file is streamed by the media server 110 the file may not be stored on the client device 130 at the conclusion of the download. In such an embodiment the transmission status may include buffering information or similar information suitable for displaying a status of the file being streamed. A step of determining whether the user has successfully completed interaction with the interactive advertisement may also be carried out prior to releasing the file for download or accepting a file for upload.

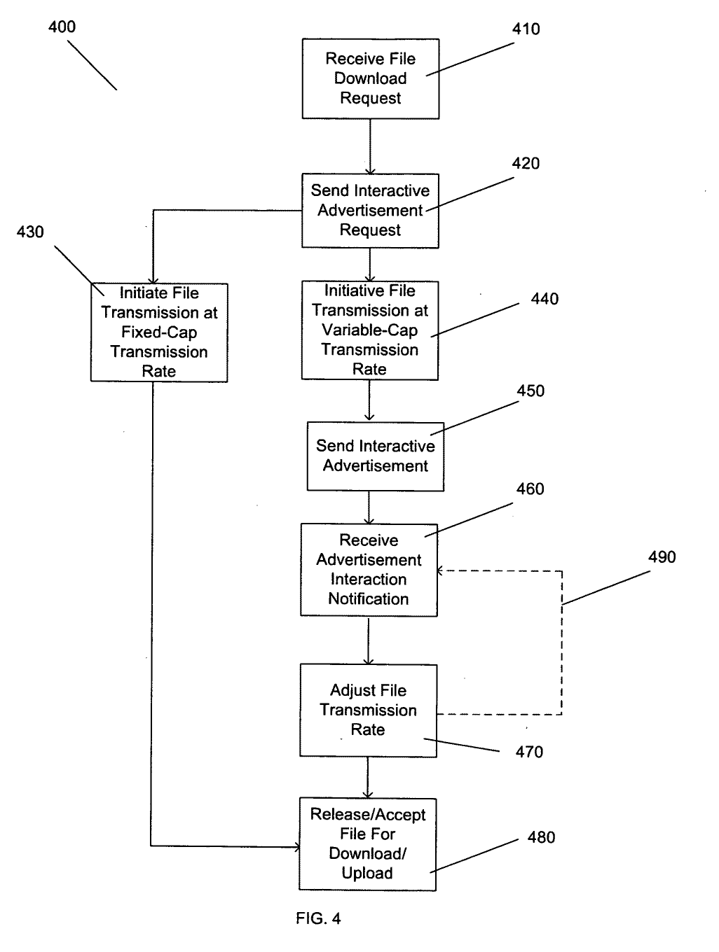

FIG. 4 is a flow diagram illustrating another process 400 that may be carried out with the exemplary interactive advertisement system 100. FIG. 4 illustrates a series of steps that occur between the media server device 110 and one of the client devices 130. The process 400 of FIG. 4 proceeds in a similar manner as the process 300 described with reference to FIG. 3. At a first step 410 the media server device 110 receives a file transmission request from the client device 130. At a next step 420, the media server module 112 sends an interactive advertisement request to the client device 130. The interactive advertisement request may comprise a plurality of file transmission rate options that the user of the client device 130 may select from. By way of example, there may be two transmission rate options such as a slower transmission rate (e.g. 100 kb/s) and a faster transmission rate (e.g. 1400 kb/s). After receiving a user selection of the desired transmission rate the media server module initiates transmission of the file at an initial transmission rate which may correspond approximately to the slowest of the optional transmission rates. The media server module may alternately initiate transmission of the file at an initial transmission rate which may correspond to either the desired transmission rate or one of the faster transmission rate options. Selection of the slowest transmission rate is an indication that the user does not want to participate in interacting with an advertisement to achieve a faster transmission rate. When the user has selected the slowest transmission rate the media server module 112 begins transmission of the file 430. The transmission rate may be capped at the slowest transmission rate while the file is transmitted to the client device. After the media server module 112 has determined the file transmission has completed the file is then released, or made available, for download or accepted for upload 480. When choosing a faster transmission rate the transmission of the file is initiated 440 at approximately the slowest rate. As discussed, the transmission of the file may alternately be initiated at approximately the desired transmission rate or the fastest of the optional transmission rates. At step 450, the media server module 112 sends the interactive advertisement to the client device 130. When selecting to participate in the interactive advertisement, the transmission rate may have a variable rate cap which may then be modulated 470 as previously discussed based on the monitored interaction 460 of the user with the interactive advertisement. The transmission rate of the file may increase up to the limit of the bandwidth otherwise available to the user as a result of the limits placed thereon by an Internet Service Provider. At step 480, the media server module 112 may release the file for download or accept the file for upload once the file has been successfully transmitted to or from the client device 130. The media server module 112 may optionally make a segment of the file available for use (e.g. viewing or listening) prior to the file being fully transmitted to the client device 130. This may occur when the media server 110 streams the file to the client device 110. When the file is streamed by the media server 110 the file may not be stored on the client device 130 at the conclusion of the download. In such an embodiment the transmission status may include buffering information or similar information suitable for displaying a status of the file being streamed. A step of determining whether the user has successfully completed interaction with the interactive advertisement may also be carried out prior to releasing the file for download or accepting the file for upload. When the file fails to completely transmit within a predetermined period of time, regardless of the transmission rate, the media server module 112 may stop the file transmission process.

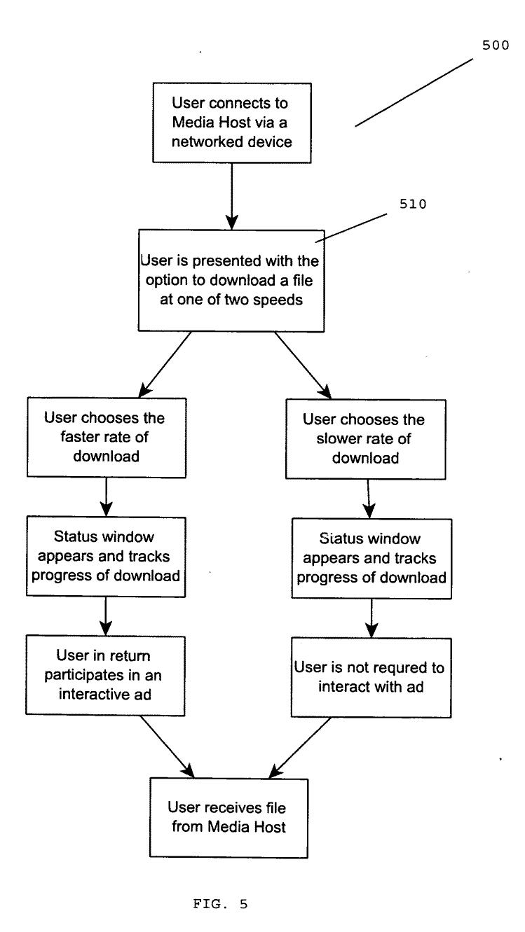

FIG. 5 is a flow diagram illustrating another process 500 that may be carried out with the exemplary interactive advertisement. FIG. 5 proceeds in a similar manner as the process described with reference to FIG. 4. In particular, FIG. 5 illustrates an embodiment in which the user is, at step 510, provided with two transmission rate options: a slower transmission rate and a higher transmission rate.

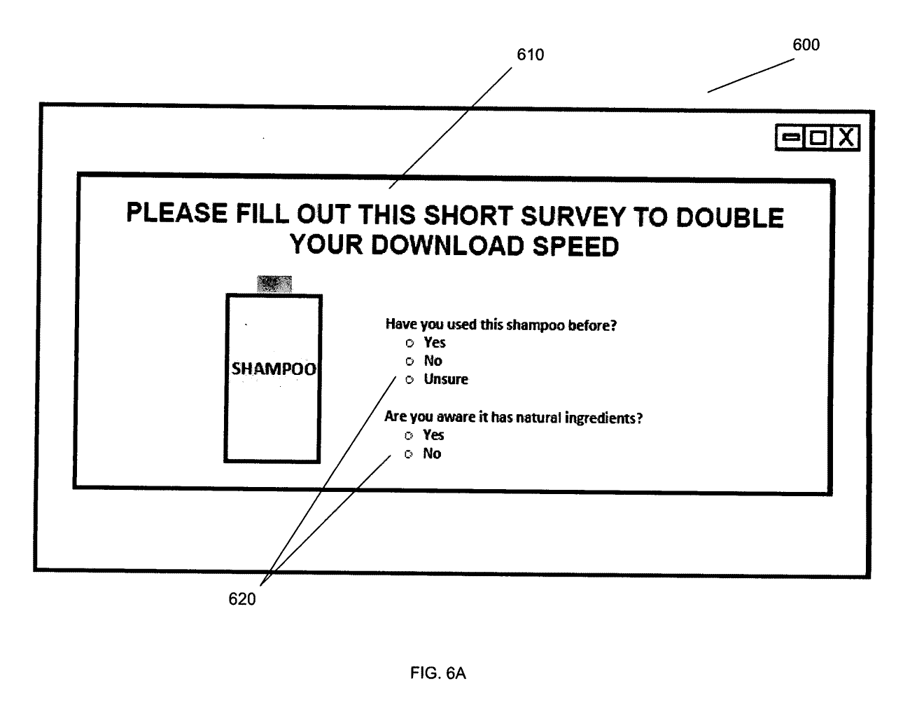

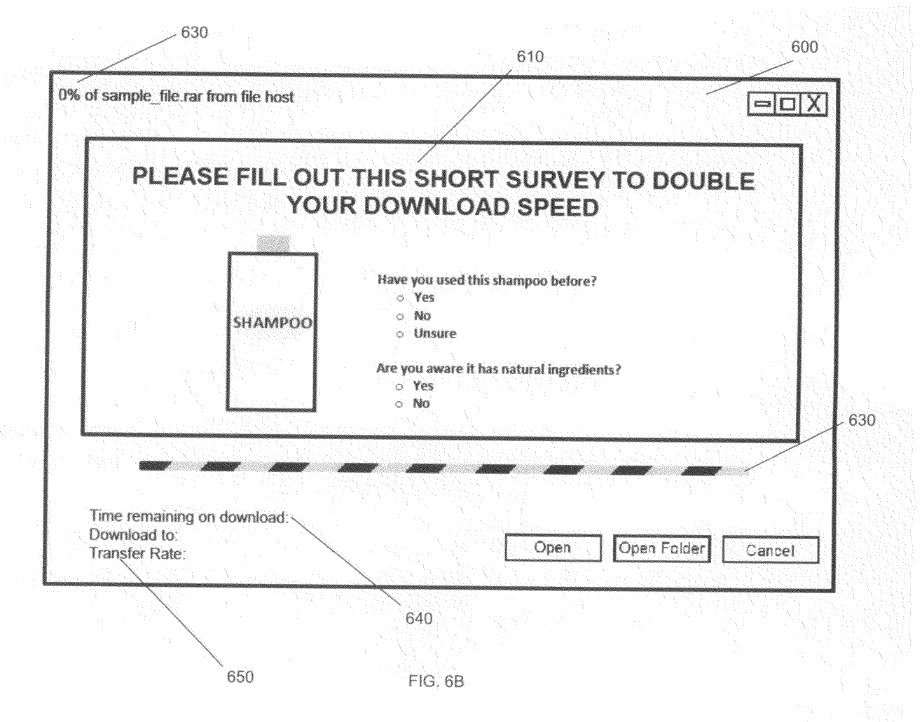

Referring now to FIGS. 6A and 6B, exemplary interface diagrams are shown for interacting with the contemplated interactive advertisement system. As shown, the client interface may be a web-browser (e.g. Firefox or Google Chrome) based interface. It is noted however that the interface may be implemented as part of a standalone application suitable for being displayed on a desktop or mobile computing device. As shown in FIG. 6A, the client interface may include a dialog box 600 displaying an advertisement 610 along with interface elements 620 (e.g. radio buttons) for allowing a user to interact with the advertisement. Instructions may be provided for indicating to the user what level of interaction is required to achieve a change in the transmission rate of the file being downloaded or streamed to the client device 130 or uploaded from the client device 130. The exemplary advertisement instructs the user to complete a survey to double the current transmission rate. It is noted that the exemplary advertisement 610 is shown for illustrative purposes only. As shown in FIG. 6B, the dialog box 600 may also include interface elements, labeled generally as 630, for displaying how much of the file has been transmitted (e.g. as a displayed percentage and/or progress bar), an interface element 640 for displaying an estimated time remaining for the download to complete and an interface element 650 for displaying the current transmission rate. When the file is delivered by streaming means, the dialog box 600 may alternately display information (e.g. buffering status) related to the status of the streamed file transmission. As shown, the advertisement 610 may be displayed in the dialog box 600 however it is noted that it may alternately be displayed as a separate interface element. By way of example, the interactive advertisement 610 may be displayed as a full page user interface element, as a floating interface element, within the wallpaper of a website, as a fold over advertisement, as a ghost advertisement, as a snipe, as a transitional advertisement or as any other format of online advertisement. The interactive advertisement may also be implemented as an advergame. The interactive advertisement may include commercial branding information, product information, service information, a request for information from the user and may also include an infomercial or a webmercial.

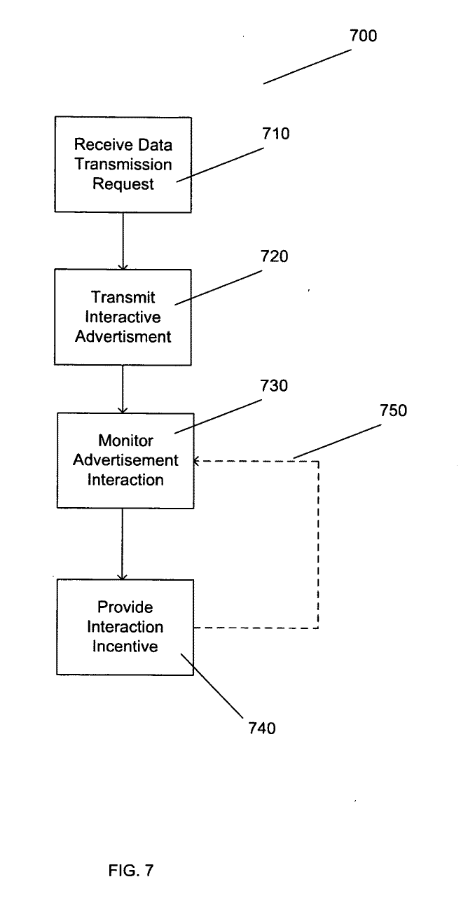

Referring now to FIG. 7, a flow diagram in shown that illustrates another computer-implemented process 700 that may be carried out with the exemplary interactive advertisement system. FIG. 7 illustrates a series of steps that occur between the media server 110 and one of the client devices 130. At a first step 710, the media server 110 receives a data transmission request from a client device 130. The data transmission request may be a request to transmit the contents of a file stored on the media server 110 or data generated by the media server 110. The request may originate from one of the client devices 130. The data being transmitted may be a multimedia file such as an audio file (e.g. a .mp3 file) or a video file (e.g. .mp4, .mov or .avi), a text-based document (e.g. .html, .xml, .rtf) such as a news article or an executable software application. The data may also include data generated dynamically by the media server 110 such as data generated by a server hosting a remote or networked gaming application (e.g. a cloud gaming application). The data transmission request may also be a request by the client device 130 to upload a locally stored file to the media server 110. The data transmission request may be initiated by a user interacting with a user interface displayed on the client device 130. By way of example the user interface may be provided within a web browser or a standalone application (e.g. a gaming application, a word-processing application or a multimedia file management application). At a next step 720, after receiving a data transmission request, the media server module 112 selects and transmits an interactive advertisement to the client device 130. As discussed, the media server module 112 may operate in conjunction with the interactive advertisement module 114 to retrieve the interactive advertisement from the data repository 116. The media server module 114 may alternately operate in conjunction with an external advertisement server 240 as was discussed with reference to FIG. 2. The response may also include information suitable for conveying data transmission parameters and associated values (e.g. current values or limitations) to the client device. The data transmission parameters may include: a data transmission rate cap (i.e. maximum transmission rate), a maximum allowed file size, a maximum allowed number of files or quantity of data allowed to be transmitted within a predetermined period of time, a maximum number of files allowed to be transmitted in parallel, file transmission waiting time or file transmission priority restrictions. The response may also include information suitable for conveying effects or potential incentives for the user to interact with the interactive advertisement. The potential incentives include positive incentives or positive effects that may be provided when the user interacts with the interactive advertisement or performs a predetermined level of interaction (e.g. completion of a survey) with the interactive advertisement. By way of example, the positive incentives for interacting with the interactive advertisement may include: increasing the data transmission rate cap (i.e. maximum transmission rate), increasing the maximum allowed file size, increasing the maximum allowed number of files or quantity of data allowed to be transmitted within a predetermined period of time, increasing the maximum number of files allowed to be transmitted in parallel, decreasing the file transmission waiting time, lifting file transmission priority restrictions, increasing the volume of available storage. The positive incentives may also include reducing the quantity or duration of future advertisements. The positive incentives may also include: increasing the quality of streaming media (e.g. upgrading to HD streaming), improving the quality of game play (e.g. increased bandwidth) and improving the functionality of game play (e.g. providing access to or enhancing game functions such as maps, awards, game modes, or player abilities). The positive incentives may also include allowing a user to view a previously withheld portion of a news article or other type of multi-media that may be consumed in segments (e.g. a video or image slide-show). The positive incentives may further include providing a less-restrictive license associated with the file being transmitted (e.g. the file may be saved to multiple machines or shared with multiple users). The potential incentives or effects may also include negative incentives or negative effects provided when the user chooses not to interact with the advertisement or fails to perform a predetermined level of interaction. By way of example, the negative potential incentives for choosing not to interact with the interactive advertisement may include: decreasing the data transmission rate cap (i.e. maximum transmission rate), decreasing the maximum allowed file size, decreasing the maximum allowed number of files or quantity of data allowed to be transmitted within a predetermined period of time, decreasing the maximum number of files allowed to be transmitted in parallel, increasing the file transmission waiting time, adding additional file transmission priority restrictions, decreasing the volume of available storage. The negative potential incentives may also include increasing the quantity or duration of future advertisements. The negative potential incentives may also include: decreasing the quality of streaming media (e.g. downgrading to lower resolution video playback), decreasing the quality of game play (e.g. decreased bandwidth) and decreasing the functionality of game play (e.g. restricting access to or crippling game functions such as maps, awards, game modes, or player abilities). The negative potential incentives may also include preventing a user from viewing a previously withheld portion of a news article or other type of multi-media that may be consumed in segments (e.g. a video or image slide-show). The negative potential incentives may further include providing a more restrictive license associated with the file being transmitted (e.g. the file may be saved to fewer machines or shared with fewer users). The information provided in the response is suitable for displaying the interactive advertisement (e.g. by displaying within a dialog box). Both the positive and negative potential incentives/effects may be provided with varying degrees such as relatively larger or smaller bandwidth changes, file size limit changes, game quality changes or changes in streaming resolution. The information provided in the response may also be suitable for displaying transmission parameters and associated values and/or potential interaction related incentives. The interactive advertisement and associated information may be displayed within a data transmission dialog box or as a separate interface element. By way of example, the interactive advertisement may be displayed as a full page user interface element, as a floating interface element, within the wallpaper or background of a website or application, as a fold over advertisement, as a ghost advertisement, as a snipe, as a transitional advertisement or as any other format of online advertisement. At a next step 730, the media server module 112 monitors the user's interaction with the interactive advertisement displayed at the client device 130. To monitor the interactive advertisement, the media server module 112 may process interaction notification messages received from the client device 130. The interaction notification messages are messages sent from the client device 130 to the media server 110 that contain status indicators related to the user's interaction with the interactive advertisement. The client module 132 may capture button clicks or similar mouse or keyboard events and include such events in the notification messages sent to the media server 110. The notification messages may be sent on a periodic basis or in response to interaction events captured by the client module 132. The client module 132 may also detect that the user has performed a predetermined level of interaction (e.g. completion of a form or survey) with the interactive advertisement and include such information in the interaction notification message. It is noted that this determination may alternately be carried out by the media server module 112. At a next step 740, the media server module 112 may provide one or more of the positive potential incentives to the user operating the client device 130 upon determining that the user has interacted with the interactive advertisement or has performed a predetermined level of interaction. The media server module 112 may provide one or more of the negative potential incentives to the user operating the client device 130 upon determining that the user has not interacted with the interactive advertisement, has decreased a rate of interaction, or has failed to perform a predetermined level of interaction within a predetermined period of time. The degree of the effect provided also may be related to the level of interaction that the user has performed with the interactive advertisement. More interaction or interaction with a higher value advertisement may result in a better effect being provided.

The media server module 112 may also send additional response messages to the client device each time an incentive has been provided (e.g. if file transmission rate cap has been modulated). The additional response messages are suitable for conveying (e.g. by displaying within a file transmission dialog box) to the user that an incentive has been provided, thereby encouraging the user to begin, continue or increase the rate at which they are interacting with the interactive advertisement.

Prior to, or at the time of transmitting the interactive advertisement, the media server module 112 may also include information for allowing the user to select a desired positive incentive, for example, by including a list of positive incentive options which the user may select from.

When transmitting a file to a client device 130, the media server module 112 initiates transmission of the file to or from the client device with a default set of transmission parameter values. By way of example, the initial transmission rate may be an uncapped rate (controlled, for example, by the physical constraints of the media server 110, the client device 130 and the user's Internet Service Provider) or may be a capped rate set by the media server 112 at a predetermined rate such as one of a plurality of transmission rate options provided to the user. In response to such notification events the media server module 112 may modify the transmission parameter values. These parameter values may be variable throughout the data transmission process thereby allowing the media server module to modulate the values at multiple times during the file transmission process, as indicated by the arrow labeled 750.

Prior to transmitting the interactive advertisement the media server module 112 may also send an interactive advertisement request to the client device 130. The request allows a user to accept or decline participation in the interactive advertisement. The interactive advertisement request may alternately provide information descriptive of any potential incentive that may be provided for participating in the interactive advertisement.

As discussed, the interactive advertisement may be an interactive interface element displayed to a user such as an online survey, form, game, product information, service information, infomercial or webmercial. However, it is noted that any advertisement displayed to the user which involves any interaction on the part of the user prior to, during or after the viewing of the advertisement may be considered an interactive advertisement. By way of example, a user agreeing to view an advertisement by taking a user interface action (e.g. a button or mouse click) is considered an interaction with the advertisement, and thus the advertisement may be considered an interactive advertisement.

A system and computerized process for interactive display of advertisements is thus contemplated. The system comprises a media server communicatively coupled to one or more client devices. The computerized process is embodied by computer program modules running on the media server and client devices that enable end users to voluntarily view and interact with an advertisement. Incentives may be offered for interacting with the advertisement. The incentives may relate to data transmission parameters such as data transmission rate. The incentives may be based on a monitored level of interaction by a user with the advertisement. Upon acceptance and/or interaction with the advertisement the maximum data transmission rate may be increased up to the limit of the bandwidth otherwise available to the user.

The various illustrative program modules and steps described in connection with the embodiments disclosed herein may be implemented as electronic hardware, computer software, or combinations of both. The various illustrative program modules and steps have been described generally in terms of their functionality. Whether the functionality is implemented as hardware or software depends in part upon the hardware constraints imposed on the system. Hardware and software may be interchangeable depending on such constraints. As examples, the various illustrative program modules and steps described in connection with the embodiments disclosed herein may be implemented or performed with an application specific integrated circuit (ASIC), a field programmable gate array (FPGA) or other programmable logic device, discrete gate or transistor logic, discrete hardware components, a conventional programmable software module and a processor, or any combination thereof designed to perform the functions described herein. The processor may be a microprocessor, CPU, controller, microcontroller, programmable logic device, array of logic elements, or state machine. The software module may reside in RAM memory, flash memory, ROM memory, EPROM memory, EEPROM memory, hard disk, a removable disk, a CD, DVD or any other form of storage medium known in the art. An exemplary processor may be coupled to the storage medium so as to read information from, and write information to, the storage medium. In the alternative, the storage medium may be integral to the processor.

In further embodiments, those skilled in the art will appreciate that the foregoing methods can be implemented by the execution of a program embodied on a computer readable medium. The medium may comprise, for example, RAM accessible by, or residing within the device. Whether contained in RAM, a diskette, or other secondary storage media, the program modules may be stored on a variety of machine-readable data storage media, such as a conventional “hard drive”, magnetic tape, electronic read-only memory (e.g., ROM or EEPROM), flash memory, an optical storage device (e.g., CD, DVD, digital optical tape), or other suitable data storage media.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A computer implemented method of performing incentivized advertising comprising:
providing a server device communicatively coupled to one or more client devices;
receiving a data transmission request from one of the one or more client devices;
transmitting an interactive advertisement to one of the one or more client devices;
determining whether a user has interacted with the interactive advertisement; and
providing an incentive to the user in response to determining whether the user has interacted with the interactive advertisement.

2. The method of claim 1, wherein the determining step further comprises determining that a user has interacted with the interactive advertisement; and the incentive is an increase in a data transmission rate.

3. The method of claim 1, wherein the determining step further comprises determining that a user has interacted with the interactive advertisement and the incentive is selected from one of: increasing a maximum data transmission rate, increasing a maximum allowed file size, increasing a maximum allowed number of files allowed to be transmitted within a predetermined period of time, increasing a maximum quantity of data allowed to be transmitted within a predetermined period of time; increasing a maximum number of files allowed to be transmitted in parallel; decreasing a file transmission waiting time; and increasing a file storage volume.

4. The method of claim 1, wherein the determining step further comprises determining that a user has interacted with the interactive advertisement and the incentive is a decrease in the quantity of future advertisements sent to the user or duration of future advertisements sent to the user.

5. The method of claim 1, wherein the determining step further comprises determining that a user has performed a predetermined level of interaction with the interactive advertisement; and the incentive is an increase in a data transmission rate.

6. The method of claim 5, wherein the predetermined level of interaction is selected from one of: completion of a survey, completion of a form and completion of a game level.

7. The method of claim 1, wherein the determining step further comprises determining that a user has not interacted with the interactive advertisement; and the incentive is a decrease in a data transmission rate.

8. The method of claim 1, wherein the determining step further comprises determining that a user has not interacted with the interactive advertisement and the incentive is selected from one of: decreasing a maximum data transmission rate, decreasing a maximum allowed file size, decreasing a maximum allowed number of files allowed to be transmitted within a predetermined period of time, decreasing a maximum quantity of data allowed to be transmitted within a predetermined period of time; decreasing a maximum number of files allowed to be transmitted in parallel; increasing a file transmission waiting time and decreasing a file storage volume.

9. The method of claim 1, wherein the determining step further comprises determining that a user has not interacted with the interactive advertisement and the incentive is an increase in the quantity of future advertisements sent to the user or duration of future advertisements sent to the user.

10. The method of claim 1, wherein the determining step further comprises determining that a user has not performed a predetermined level of interaction with the interactive advertisement; and the incentive is a decrease in a data transmission rate.

11. The method of claim 10, wherein the predetermined level of interaction is selected from one of: completion of a survey, completion of a form and completion of a game level.

12. The interactive advertising method of claim 1, wherein the data transmission request is a request to download a file from the server.

13. The interactive advertising method of claim 12, wherein the determining step further comprises determining that a user has performed a predetermined level of interaction with the interactive advertisement; and
releasing the requested file for download in response to said determining.

14. The interactive advertising method of claim 1, wherein the data transmission request is a request to upload a file to the server.

15. The interactive advertising method of claim 1, wherein the data transmission request is a request to stream a multimedia file from the server.

16. The interactive advertising method of claim 1, wherein the data transmission request is a request to play a gaming application hosted on the server.

17. The interactive advertising method of claim 1, further comprising:
receiving one or more interaction notification messages from one of the one or more client devices, the interaction notification messages indicating a user's interaction with the interactive advertisement;
wherein said steps of determining and providing are carried out in response to receiving said interaction notification messages.

18. The interactive advertising method of claim 1, wherein the interactive advertisement is selected from one of: a survey and a game.

19. A computer implemented method of performing incentivized advertising comprising:
providing a server device communicatively coupled to one or more client devices;
receiving a data transmission request from one of the one or more client devices;
sending an interactive advertisement request to the client device;
transmitting the requested data with a fixed maximum transmission rate when a user declines the interactive advertisement request; and
transmitting the requested data with a variable maximum transmission rate when a user accepts the interactive advertisement request.

20. The method of claim 19, wherein the interactive advertisement request comprises a request for a user to select between a slower data transmission speed indicating that the user declines the interactive advertisement request and a higher data transmission speed indicating that the user accepts the interactive advertisement request.

21. The method of claim 20, further comprising:
transmitting an interactive advertisement to one of the one or more client devices when the user accepts the interactive advertisement request;
determining whether the user has interacted with the interactive advertisement; and
providing an incentive to the user in response to determining whether the user has interacted with the interactive advertisement.

22. An interactive advertising system comprising:
one or more client devices configured to display an interactive advertisement; and
a media server, the media server device being communicatively coupled to the one or more client devices and having:
a media server module containing instructions executable by a processor for:
receiving a data transmission request from one of the one or more client devices;
transmitting an interactive advertisement to one of the one or more client devices;
determining whether a user has interacted with the interactive advertisement; and
providing an incentive to the user in response to determining whether the user has interacted with the interactive advertisement.

23. A computer implemented method of providing interactive advertising comprising:
providing a server device communicatively coupled to one or more client devices;
receiving a data transmission request from one of the one or more client devices;
sending an interactive advertisement to one of said one or more client devices;
receiving one or more notification messages from one of the one or more client devices, the notification messages indicating a user's interaction with the interactive advertisement; and
providing an incentive to the user upon determining that the user has interacted with the interactive advertisement.

24. The method of claim 23, wherein the incentive is an improvement in one or more data transmission parameters.

25. The method of claim 23, wherein the incentive is selected from one of: increasing a maximum data transmission rate, increasing a maximum allowed file size, increasing a maximum allowed number of files allowed to be transmitted within a predetermined period of time, increasing a maximum quantity of data allowed to be transmitted within a predetermined period of time; increasing a maximum number of files allowed to be transmitted in parallel; decreasing a file transmission waiting time; and increasing a file storage volume.

26. The method of claim 23, wherein the incentive is a decrease in the quantity of future advertisements sent to the user.

27. The method of claim 23, wherein the incentive is an improvement in game play.

28. A computer implemented method of providing interactive advertising comprising:
providing a server device adapted to be communicatively coupled to one or more client devices;
sending an interactive advertisement to one of said one or more client devices;
receiving one or more notification messages from one of the one or more client devices, the one or more notification messages indicating a user's interaction with the interactive advertisement; and
modifying one or more data transmission parameters in response to receiving the one or more notification messages.

29. The interactive advertising method of claim 28, wherein one of said one or more data transmission parameters is a data transmission rate, and wherein said modifying further comprises increasing said data transmission rate when determining from said one or more notification messages that a user has interacted with the interactive advertisement.

30. The interactive advertising method of claim 28, wherein one of said one or more data transmission parameters is a data transmission rate, and wherein said modifying further comprises increasing said data transmission rate when determining from said one or more notification messages that a user has performed a predetermined level of interaction with the interactive advertisement.

31. The interactive advertising method of claim 30, wherein the interactive advertisement is a survey and the predetermined level of interaction is completion of the survey by the user.

32. The interactive advertising method of claim 28, further comprising:
receiving a data transmission request from one of the one or more client devices;
sending an interactive advertisement request to one of the one or more client devices; and
transmitting the requested data with a fixed maximum transmission rate when a user declines the interactive advertisement request.

33. The interactive advertising method of claim 28, further comprising:
receiving a data transmission request from one of the one or more client devices;
sending an interactive advertisement request to one of the one or more client devices; and
transmitting the requested data with a variable maximum transmission rate when a user accepts the interactive advertisement request.

34. The interactive advertising method of claim 33, wherein the data transmission request is a request to download a file from the server.

35. The interactive advertising method of claim 33, wherein the maximum data transmission rate is increased by the server upon determining from said one or more notification messages that a user has interacted with the interactive advertisement.

36. The interactive advertising method of claim 33, further comprising:
determining from said one or more notification messages that a user has performed a predetermined level of interaction with the interactive advertisement; and
releasing the requested file for download in response to said determining.

37. The interactive advertising method of claim 33, further comprising:
determining from said one or more notification messages that a user has not interacted with the interactive advertisement or has stopped interacting with the interactive advertisement; and
decreasing the maximum data transmission rate in response to said determining.

38. A computer implemented method of providing interactive advertising comprising:
providing a server device communicatively coupled to one or more client devices;
receiving a data transmission request from one of the one or more client devices;
sending an interactive advertisement to one of said one or more client devices;
receiving one or more notification messages from one of the one or more client devices, the notification messages indicating the level of interaction undertaken by a user with the interactive advertisement; and
providing at least one effect to the user with the effect being determined based upon the level of interaction undertaken by the user with the interactive advertisement.

39. The method of claim 38, wherein the determining further comprises determining that a user has interacted with the interactive advertisement; and the effect is an increase in a data transmission rate.

40. The method of claim 38, wherein the determining further comprises determining that a user has interacted with the interactive advertisement and the effect is a positive effect selected from one of: increasing a maximum data transmission rate, increasing a maximum allowed file size, increasing a maximum allowed number of files allowed to be transmitted within a predetermined period of time, increasing a maximum quantity of data allowed to be transmitted within a predetermined period of time; increasing a maximum number of files allowed to be transmitted in parallel; decreasing a file transmission waiting time; and increasing a file storage volume.

41. The method of claim 38, wherein the determining further comprises determining that a user has interacted with the interactive advertisement and the effect is a decrease in the quantity of future advertisements sent to the user or duration of future advertisements sent to the user.

42. The method of claim 38, wherein the determining further comprises determining that the user has performed a predetermined level of interaction with the interactive advertisement; and the effect is an increase in a data transmission rate.

43. The method of claim 42, wherein the predetermined level of interaction is selected from one of: completion of a survey, completion of a form and completion of a game level.

44. The method of claim 38, wherein the determining further comprises determining that a user has not interacted with the interactive advertisement; and the effect is a decrease in a data transmission rate.

45. The method of claim 38, wherein the determining further comprises determining that a user has not interacted with the interactive advertisement and the effect is a negative effect selected from one of: decreasing a maximum data transmission rate, decreasing a maximum allowed file size, decreasing a maximum allowed number of files allowed to be transmitted within a predetermined period of time, decreasing a maximum quantity of data allowed to be transmitted within a predetermined period of time; decreasing a maximum number of files allowed to be transmitted in parallel; increasing a file transmission waiting time and decreasing a file storage volume.

46. The method of claim 38, wherein the determining further comprises determining that a user has not interacted with the interactive advertisement and the effect is an increase in the quantity of future advertisements sent to the user or duration of future advertisements sent to the user.

47. The method of claim 38, wherein the determining further comprises determining that a user has not performed a predetermined level of interaction with the interactive advertisement; and the effect is a decrease in a data transmission rate.

48. The method of claim 47, wherein the predetermined level of interaction is selected from one of: completion of a survey, completion of a form and completion of a game level.

49. The interactive advertising method of claim 38, wherein the data transmission request is a request to download a file from the server.

50. The interactive advertising method of claim 49, wherein the determining further comprises determining that a user has performed a predetermined level of interaction with the interactive advertisement and the effect is releasing the requested file for download.

51. The interactive advertising method of claim 38, wherein the data transmission request is a request to upload a file to the server.

52. The interactive advertising method of claim 38, wherein the data transmission request is a request to stream a multimedia file from the server.

53. The interactive advertising method of claim 38, wherein the data transmission request is a request to play a gaming application hosted on the server.

54. The interactive advertising method of claim 38, further comprising:
receiving one or more interaction notification messages from one of the one or more client devices, the interaction notification messages indicating a user's interaction with the interactive advertisement;
wherein the providing step is carried out in response to receiving said interaction notification messages.

55. The interactive advertising method of claim 38, wherein the interactive advertisement is selected from one of: a survey, a form, a game, product information, service information, branding information, a request for information from the user, an infomercial, and a webmercial.

56. The interactive advertising method of claim 38, wherein the effect is selected from one of a plurality of predetermined effects.

57. The interactive advertising method of claim 56, wherein the effect is selected in a random manner.

58. The interactive advertising method of claim 56, wherein the provided effect is a positive effect when the notification messages indicate that the user has interacted with the interactive advertisement at least once.

59. The interactive advertising method of claim 56, wherein the provided effect is a positive effect when the notification messages indicate that the user has interacted with the interactive advertisement at least once.

60. The interactive advertising method of claim 56, wherein the provided effect is a plurality of positive effects when the notification messages indicate that the user has interacted with the interactive advertisement more than once.

61. The interactive advertising method of claim 56, wherein the effects include a plurality of positive effects having varying levels of value, and wherein a positive effect having a higher value is provided when the notification messages indicate that the user has interacted with the interactive advertisement more than once.

62. The interactive advertising method of claim 56, wherein the provided effect is a negative effect when the notification messages indicate that the user has not interacted with the interactive advertisement.

63. The interactive advertising method of claim 56, wherein the provided effect is a negative effect when the notification messages indicate that the user has not interacted with the interactive advertisement for a predetermined period of time.
